(19) United States
(12) Patent Application Publication
(10) Pub. No.: US 2015/0095049 A1
(43) Pub. Date: Apr. 2, 2015

(54) Systems, Computer Medium and Computer-Implemented Methods for Quantifying and Employing Impacts of Workplace Wellness Programs

(71) Applicant: Saudi Arabian Oil Company, Dhahran (SA)

(72) Inventors: Samantha J. Horseman, Dhahran (SA); Khalid Tofig Al-Dhubaib, Cleveland, OH (US)

(21) Appl. No.: 14/043,898

(22) Filed: Oct. 2, 2013

(51) Int. Cl. G06F 19/00; G06Q 10/10; G06Q 50/22

(52) U.S. Cl. CPC G06F 19/3431; G06Q 50/22; G06Q 10/105
USPC 705/2

(57) ABSTRACT

Provided are embodiments of systems, computer medium and computer-implemented methods for quantifying impacts of workplace wellness programs. Methods include receiving cohort health risk data for cohort groups subject to a workplace wellness program, direct cost data, and total cost data, normalizing the cohort health risk data to generate a normalized number of risk avoided, determining an average direct cost associated with a health risk, determining a ratio of total cost avoided to medical cost avoided, and determining a presenteeism value indicative of a total cost avoided over the given duration of time based at least in part on a product of the normalized number of risk avoided, a number of employees subject to the workplace wellness program, the average medical cost associated with a health risk and the ratio of total cost avoided to direct cost avoided.

### FIELD OF INVENTION

The present invention relates generally to wellness programs and more particularly to systems, machines, non-transitory computer readable medium having program instructions stored thereon, and computer-implemented methods for quantifying and employing impacts of wellness programs.

### BACKGROUND OF THE INVENTION

Organizations (e.g., companies) are often looking for cost-effective and efficient methods to improve employee safety, health and wellness. In some instances, organizations employ workplace wellness programs to facilitate healthy and positive lifestyles. A workplace wellness program may include activities or organizational policies designed to support healthy behavior in the workplace and improve the health of employees and their families. Wellness programs may involve a variety of activities such as health fairs, health education classes, physical activity classes, medical/health screenings, health coaching, weight management programs, injury prevention programs, fitness programs, and the like. Wellness programs may also include providing information and facilities to support healthy lifestyle including, such as health literature, on-site fitness facilities, on-site medical clinics, and so forth. In some instances, wellness programs include organizational policies designed to facilitate a healthy work environment including, for example, allowing flex time for exercise, providing on-site kitchen and eating areas, offering healthy food options in vending machines, offering financial and other incentives for participation, and so forth.

It is believed that workplace wellness program features can lead to a “culture of health” within a workplace that can help to prevent injury and sickness, while also providing a positive impact on workforce biometric health behaviors, performance, and work factors. For example, workplace wellness programs are often associated with reductions of health risks (e.g., health risk associated with body mass index (BMI), blood pressure (BP), and body fat percentage) and improved work factors (e.g., improved job satisfaction, stress management, work engagement, and productivity). Moreover, workplace wellness programs can provide a positive financial benefit for organizations. For example, a company may see a reduction in medical costs due to medical risks/conditions that are avoided as a result of a workplace wellness program, as well as revenue increases attributable to improved work factors (e.g., increases productivity due to improved health, reduced stress, and the like).

Although it is generally accepted that workplace wellness programs have a positive impact on employee safety, health and wellness, it is often difficult to quantify the impact of a workplace wellness program. For example, it may be difficult to attribute cost savings and/or increased revenue to a workplace wellness program. In some instances cohort studies of workplace wellness program participates are undertaken in an effort to assess whether the program is having a positive impact and to what extent. Unfortunately, these studies can be expensive, time consuming, and inaccurate. For example, cohort studies may rely on employee submission of surveys/questionnaires that can require a large number of resources to obtain and may be inaccurate due to subjective responses of employees. Thus, in many instances an organization cannot effectively assess the impact of a wellness program, and, as a result, organizations may not be able to determine whether changes to a wellness program are having a positive impact, or in some instances may not have a means to justify maintaining a workplace wellness program. That is, without having a clear picture of the financial benefits of a workplace program, a company may forgo the workplace wellness program in view of its cost.

### SUMMARY OF THE INVENTION

Applicants have recognized several shortcomings of existing systems and methods for assessing impacts of workplace wellness programs and, in view of these shortcomings, has recognized the need for system and methods that can effectively quantify impacts of workplace wellness programs. Applicants have recognized that although existing systems and method for assessing workplace wellness programs provide some indication of impacts of wellness programs, they may be expensive, time consuming, and inaccurate. For example, cohort studies may rely on employee submission of surveys/questionnaires that can require a large number of resources to obtain and that may be inaccurate due to subjective responses of employees. Thus, existing systems and method for assessing impacts of workplace wellness programs fail to provide a framework for efficiently quantifying impacts of workplace wellness programs. Applicants have recognized that such shortcomings have failed to be addressed by others, and have recognized that such shortcomings may be addressed by systems and methods that can employ workplace wellness program data (e.g., population health risk profiles of cohorts subject to the workplace wellness program) to identify a rate of savings (e.g., a “presenteeism value”) associated with the workplace wellness program. Such a system may reduce the overall complexity of systems and methods for assessing workplace wellness programs, while providing quantitative values indicative of financial impacts of workplace wellness programs. In view of the foregoing, various embodiments of the present invention advantageously provide systems, machines, non-transitory computer storage medium having program instructions stored thereon, and computer-implemented methods for quantifying and employing impacts of workplace wellness programs.

In some embodiments, provided is a workplace wellness system that includes a wellness database, a presenteeism module and a wellness program module. The wellness database adapted to store workplace wellness program data. The workplace wellness program data including cohort health risk data for one or more cohort groups subject to the workplace wellness program, direct cost data indicative of an average medical cost associated with a health risk, and total cost data indicative of a ratio of total cost avoided to medical cost avoided. The cohort health risk data for each cohort group including an entry population health risk profile indicative of health risk categorizations for employees in the cohort group at a start of a time span associated with the cohort group, and an exit population health risk profile indicative of health risk categorizations for the employees in the cohort group at an end of the time span associated with the cohort group. The presenteeism module adapted to receive the workplace wellness program data, determine a number of employees subject to the workplace wellness program, normalize the cohort health risk data for the one or more cohort groups to generate a normalized number of risk avoided per employee for a given duration of time, determine an average medical cost associated with a health risk based at least in part on the direct cost data, determine a ratio of total cost avoided to medical cost avoided based at least in part on the total cost data, and determine a presenteeism value indicative of a total cost avoided over the given duration of time based at least in part on a product of the normalized number of risk avoided per employee for the given duration of time, the number of employees subject to the workplace wellness program, the average medical cost associated with a health risk and the ratio of total cost avoided to medical cost avoided. The wellness program module adapted to receive the presenteeism value from the presenteeism module, determine whether the presenteeism value satisfies a presenteeism value threshold, and, in response to determining that the presenteeism value does not satisfy the presenteeism value threshold, generate a modified version of the workplace wellness program and serve, to a client device for display, a workplace wellness program content page comprising information regarding the modified version of the workplace wellness program.

In certain embodiments, normalizing the cohort health risk data for the one or more cohort groups to generate a normalized number of risk avoided per employee for a given duration of time includes: for each of the one or more cohort groups, determining a rate of risk avoidance for the given duration of time based at least in part on shifts in health risks categorizations between the entry population health risk profile and the exit population health risk profile, and averaging the rates of risk avoidance for the one or more cohort groups to generate the normalized number of risk avoided per employee for the given duration of time.

In some embodiments, provided is a workplace wellness program system for quantifying an impact of a workplace wellness program. The system including one or more processors, and one more memories storing program instructions that are executable by the one more processors to cause the following step: receive workplace wellness program data including cohort health risk data for one or more cohort groups subject to the workplace wellness program, direct cost data indicative of an average direct cost associated with a health risk, and total cost data indicative of a ratio of total cost avoided to direct cost avoided. The cohort health risk data for each cohort group including a first population health risk profile indicative of health risk categorizations for employees in the cohort group at a start of a time span associated with the cohort group, and a second population health risk profile indicative of health risk categorizations for the employees in the cohort group at an end of the time span associated with the cohort group. The program instructions being executable by the one more processors to cause the following additional steps: determine a number of employees subject to the workplace wellness program, normalize the cohort health risk data for the one or more cohort groups to generate a normalized number of risk avoided per employee for a given duration of time, determine an average direct cost associated with a health risk based at least in part on the direct cost data, determine a ratio of total cost avoided to direct cost avoided based at least in part on the total cost data, and determine a presenteeism value indicative of a total cost avoided over the given duration of time based at least in part on a product of the normalized number of risk avoided per employee for the given duration of time, the number of employees subject to the workplace wellness program, the average direct cost associated with a health risk and the ratio of total cost avoided to direct cost avoided.

In certain embodiments, normalizing the cohort health risk data for the one or more cohort groups to generate a normalized number of risk avoided per employee for a given duration of time includes: for each of the one or more cohort groups, determining a rate of risk avoidance for the given duration of time based at least in part on shifts in health risks categorizations between the first population health risk profile and the second population health risk profile, and averaging the rates of risk avoidance for the one or more cohort groups to generate the normalized number of risk avoided per employee for the given duration of time.

In some embodiments, the steps further include determining an estimated number of risks avoided based at least in part on a product of the normalized number of risk avoided and the number of employees subject to the workplace wellness program, determining a direct cost avoided based at least in part on a product of the average direct cost associated with a health risk and the estimated number of risks avoided, determining an indirect cost avoided based at least in part on a product of the average direct cost avoided and the ratio of indirect cost to direct cost.

In certain embodiments, the steps further include generating a modified version of the workplace wellness program based at least in part on the presenteeism value. In some embodiments, the steps further include: determining whether the presenteeism value satisfies a presenteeism value threshold, and in response to determining that the presenteeism value does not satisfy the presenteeism value threshold: generating a modified version of the workplace wellness program, and providing for display of a workplace wellness program content page comprising information regarding the modified version of the workplace wellness program.

In some embodiments, provided is a computer-implemented method for quantifying an impact of a workplace wellness program. The method including receiving workplace wellness program data including: cohort health risk data for one or more cohort groups subject to the workplace wellness program, direct cost data indicative of an average direct cost associated with a health risk, and total cost data indicative of a ratio of total cost avoided to direct cost avoided. The cohort health risk data for each cohort group including a first population health risk profile indicative of health risk categorizations for employees in the cohort group at a start of a time span associated with the cohort group, and a second population health risk profile indicative of health risk categorizations for the employees in the cohort group at an end of the time span associated with the cohort group. The method also including determining a number of employees subject to the workplace wellness program, normalizing the cohort health risk data for the one or more cohort groups to generate a normalized number of risk avoided per employee for a given duration of time, determining an average direct cost associated with a health risk based at least in part on the direct cost data, determining a ratio of total cost avoided to direct cost avoided based at least in part on the total cost data, and determining a presenteeism value indicative of a total cost avoided over the given duration of time based at least in part on a product of the normalized number of risk avoided per employee for the given duration of time, the number of employees subject to the workplace wellness program, the average direct cost associated with a health risk and the ratio of total cost avoided to direct cost avoided.

In certain embodiments, provided is a non-transitory computer readable storage medium having program instructions stored thereon that are executable by one or more processors to cause the following step for quantifying an impact of a workplace wellness program: receive workplace wellness program data including cohort health risk data for one or more cohort groups subject to the workplace wellness program, direct cost data indicative of an average direct cost associated with a health risk, and total cost data indicative of a ratio of total cost avoided to direct cost avoided. The cohort health risk data for each cohort group including a first population health risk profile indicative of health risk categorizations for employees in the cohort group at a start of a time span associated with the cohort group, and a second population health risk profile indicative of health risk categorizations for the employees in the cohort group at an end of the time span associated with the cohort group. The program instructions being executable by the one more processors to cause the following additional steps: determine a number of employees subject to the workplace wellness program, normalize the cohort health risk data for the one or more cohort groups to generate a normalized number of risk avoided per employee for a given duration of time, determine an average direct cost associated with a health risk based at least in part on the direct cost data, determine a ratio of total cost avoided to direct cost avoided based at least in part on the total cost data, and determine a presenteeism value indicative of a total cost avoided over the given duration of time based at least in part on a product of the normalized number of risk avoided per employee for the given duration of time, the number of employees subject to the workplace wellness program, the average direct cost associated with a health risk and the ratio of total cost avoided to direct cost avoided.

Accordingly, as described herein, embodiments of the system, computer program instructions and associated computer-implemented methods provide for quantifying and employing impacts of workplace wellness programs.

### BRIEF DESCRIPTION OF THE DRAWINGS

FIGS. 1A and 1B are diagrams that illustrate population health risk profiles and health risk migrations between health risk categories of the population health risk profiles in accordance with one or more embodiments of the present invention.

FIG. 2 is a diagram that illustrates a wellness environment in accordance with one more embodiments of the present invention.

FIG. 3 is a flow diagram that illustrates operations of a wellness system in accordance with one more embodiments of the present invention.

FIG. 4 is a flowchart that illustrates a method of assessing a wellness program in accordance with one or more embodiments of the present invention.

FIG. 5 is a flowchart that illustrates a method of determining a presenteeism value in accordance with one or more embodiments of the present invention.

FIG. 6 is a flowchart that illustrates a method of adjusting a wellness program in accordance with one or more embodiments of the present invention.

FIG. 7 illustrates an exemplary workplace wellness program page in accordance with one or more embodiments of the present invention.

FIG. 8 is a block diagram that illustrates components of a wellness system in accordance with one more embodiments of the present invention.

While the invention is susceptible to various modifications and alternative forms, specific embodiments of the invention are shown by way of example in the drawings and will be described in detail herein. It should be understood, however, that the drawings and detailed description thereof are not intended to limit the invention to the particular form disclosed, but to the contrary, are intended to cover all modifications, equivalents, and alternatives falling within the spirit and scope of the present invention as defined by the appended claims.

### DETAILED DESCRIPTION

Presenteeism may refer to loss of productivity due to poor health. That is, although an employee may be present at work, if they are in poor health, their productivity may suffer, decreasing revenue and effectively increasing costs. In some embodiments, provided are a wellness systems and methods that can determine and employ presenteeism values associated with workplace wellness programs. A presenteeism value for a workplace wellness program may include a value indicative of cost savings that are attributable to the workplace wellness program. In some embodiments, a presenteesim value is representative of a cost savings attributable to improved health of employees, including direct cost savings (e.g., medical costs avoided due to improved employee health) and/or indirect cost savings (e.g., increased productivity and revenue due to improved employee health). In some embodiments, a presenteeism value is indicative of a rate of change in cost savings over a given period of time. For example, a presenteeism value for a workplace wellness program may be expressed as $3.24 million per year, indicating that the workplace wellness program is attributed with saving an organization approximately $3.24 million per year. Such a presenteeism value may enable an organization to determine a financial impact of the workplace wellness program. For example, a positive presenteeism value may represent a positive trend in cost savings attributed to the workplace wellness program (e.g., a presenteeism value of $3.24 million may indicate that savings increased from $50 million to $53.24 million over a year). In contrast, a negative presenteeism may represent a negative trend in cost savings attributed to the workplace wellness program (e.g., a presenteeism value of −$3.24 million may indicate that savings decreased from $50 million to $46.76 million over a year). Thus, with the determination of a presenteeism value, an organization is provided with a means to assess the effectiveness of a workplace wellness program, to assess trends in the presenteeism value to see if the program needs to be modified to help increase its effective rate of return (e.g., change organizational wellness policies to reflect those associated with higher presenteeism values) and/or to justify the outlay of costs associated with the workplace wellness program (e.g., an amount of savings that can be compared to the amount of money being spent on the workplace wellness program to determine whether the program is in fact paying for itself).

In some embodiments, a presenteeism value for a workplace wellness program is determined based on wellness program data for one or more cohorts subject to the workplace wellness program. For example, where a first cohort includes a first group of employees (e.g., 6,366 employees) subject to (e.g., participating in) a workplace wellness plan over a first time span (e.g., 2007-2009) and a second cohort includes a second group of employees (e.g., 1,157 employees) subject to the workplace wellness plan for a second time span (e.g., 2005-2011), a presenteeism value for the workplace wellness program may be determined based on wellness program data for one or both of the cohorts. Although certain embodiments are described herein with regard to two cohorts for the purpose of illustration, embodiments may include employing wellness program data from any number of cohorts (e.g., one cohort, three cohorts, four cohorts, or the like) to generate a presenteeism value for a workplace wellness program.

In some embodiments, wellness program data for a cohort includes entry and exit data for the cohort. For example, wellness data for the first cohort described above may include entry cohort data corresponding to characteristics of the first cohort on or about Jan. 1, 2007 and exit cohort data corresponding to characteristics of the first cohort on or about Jan. 1, 2009. In some embodiments, the wellness program data for a cohort includes population health risk profiles indicative of a distribution of the population into various health risk categories.

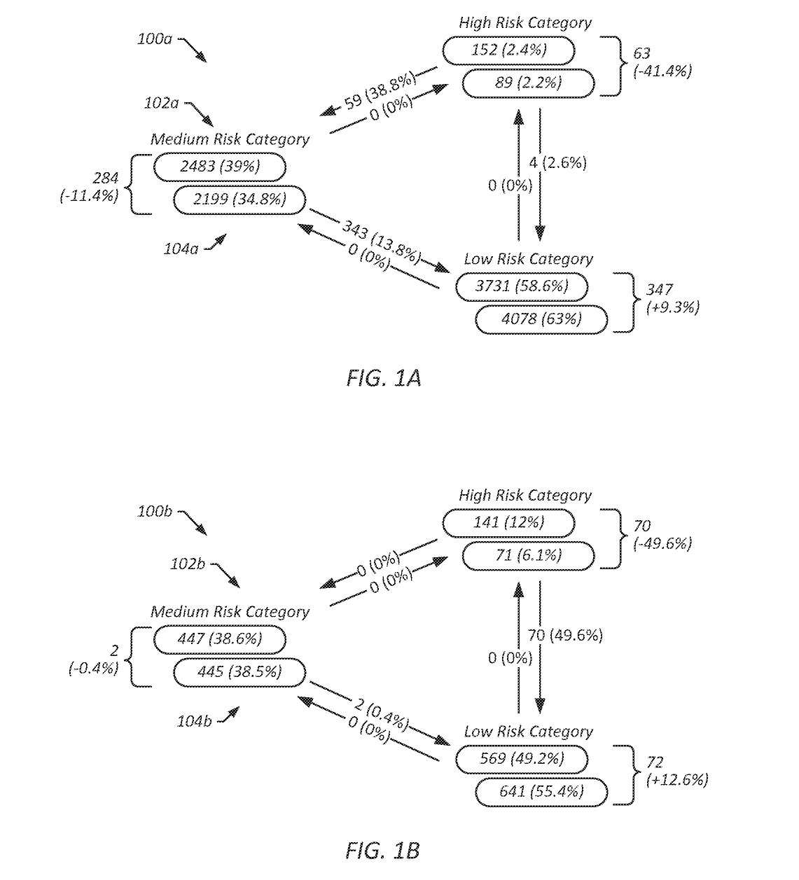

FIGS. 1A and 1B are diagrams that illustrate population health risk profiles and health risk migrations between health risk categories of the population health risk profiles in accordance with one or more embodiments of the present invention. FIGS. 1A and 1B include Markov models 100a and 100b that are indicative of population health risk migrations of a first cohort and a second cohort, respectively. Models 100a and 100b include representations of first/entry population health risk profiles 102a and 102b and second/exit population profiles 104a and 104b, respectively. A first/entry population health risk profile may correspond to characteristics of a cohort on or about a start/beginning of a timespan corresponding to the cohort. A second/exit population health risk profile may correspond to characteristics of a cohort on or about an end of a timespan corresponding to the cohort. For example, first/entry population health risk profile 102a for a cohort having a population of 6366 participants may specify that 152 participants in the first cohort (e.g., 2.4% of the cohort group's population) are categorized as high risk, that 2,483 participants in the first cohort (e.g., 39% of the cohort group's population) are categorized as medium risk, and that 3731 participants in the first cohort (e.g., 58.6% of the cohort group's population) are categorized as low risk on or about Jan. 1, 2007. Second/exit population health risk profile 104a may specify that 89 participants in the first cohort (e.g., 2.2% of the cohort group's population) are categorized as high risk, that 2,199 participants in the second cohort (e.g., 34.8% of the cohort group's population) are categorized as medium risk, and that 4078 participants in the second cohort (e.g., 63% of the cohort group's population) are categorized as low risk on or about Jan. 1, 2009. First/entry population health risk profile 102b and second/exit population profile 104b may provide similar data population health risk profile information for characteristics of the second cohort on or about Jan. 1, 2005 and Jan. 1, 2011, respectively.

In some embodiments, wellness program data includes direct cost data. Direct cost data may be indicative of direct costs, such as medical costs, associated with a risk. For example, direct cost data may include a specified medical cost of $1503 per risk (MCPR). Medical costs may include doctor's bills paid by an organization, costs for insurance claims associated with a health risks, or other readily quantifiable cost associated with a health risk. In some embodiments, the direct cost data includes medical costs associated with multiple risks that can be used to determine a medical cost per risk. For example, direct cost data may include a listing of medical cost of $1616 for Body Mass Index (BMI) risks, $876 Blood Pressure (Pre HTN) risks, $950 Blood Pressure (HTN) risks, $961 Physical Activity risks, $965 Tobacco risks, $2533 Musculoskeletal (Low Back Pain) risks, $1870 Musculoskeletal (Shoulder Pain) risks and $1718 for Stress risks, and so forth. These medical costs per risk can be averaged to determine an average medical cost per risk (e.g., an average medical cast per risk of $1503).

In some embodiments, wellness program data includes indirect cost data. Indirect cost data may be indicative of a ratio of indirect costs to direct costs associated with a risk. Indirect costs may include costs that are not readily quantifiable. For example, indirect costs may include revenue decreases due to decreased employee productivity attributable to a health risk or the like. In some embodiments, indirect cost data may specify or otherwise be indicative of a cost ratio of about 4:1 indicative a ratio of about $4 in indirect cost being attributable to a health risk for every $1 of direct costs attributable to a health risk. For example, indirect cost data may specify a cost ratio of 3.7:1. Such a ratio may be indicative of a $3.7 of indirect costs for every $1 of direct costs associated with a health risk. Thus, for example, a total of $4.7 of total costs may be saved for every $1 of direct costs avoided. Such a ratio may be derived based on studies of populations and the relationships between indirect cost and direct costs (e.g., medical costs). The cost ratio may be referred to as a cost relationship constant (e.g., a 4.7 cost relationship constant).

In some embodiments, a presenteeism value for a workplace wellness program is calculated based on the following presenteeism equation:

$$\frac{d C}{d t} = 4.7 \times μ \times ψ \times \{ \frac{d {P}_{L}}{d t} {R}_{L} + \frac{d {P}_{M}}{d t} {R}_{M} + \frac{d {P}_{H}}{d t} {R}_{H} \} \qquad ( 1 )$$

Where dC/dt is a presenteeism value (e.g., a cost avoidance due to medical risks avoided over a given period of time, dt), 4.7 is a cost relationship constant, μ is a medical cost avoided value (e.g., a medical cost per risk), ψ is a total population value (e.g., a number of participants in the workplace wellness program), dP_{L}, dP_{M} and dP_{H} are low, medium and high risk migrations respectively (e.g., a change in the number of participants in the low, medium and high risk categories, respectively), R_{L}, R_{M} and R_{H} are low, medium and high risk numbers (e.g., the number of risk associated with the low, medium and high categories, respectively). Although the cost relationship constant is listed as 4.7 for the purpose of illustration, embodiments may include any suitable cost relationship constant. For example, if direct cost (e.g., medical cost) were to increase significantly without a proportional increase in indirect cost associated with a risk, the cost relationship constant may be adjusted (e.g., decreased) to account for changes in the ratio of indirect cost to direct cost.

In some embodiments, risk migrations are determined based on normalizing of risk migrations for corresponding cohort data. For example, where a population profile includes three risk categories (e.g., low, medium and high risk categories), risk migrations (dP) for each category may be determined based on a difference in the number of participants in each of the categories at the start and end of the corresponding time span as indicated by the respective population health risk profiles. In some embodiments, the risk migration includes a percentage change in the number of participants in the given category. In accordance with the population health risk profiles 102a and 104a for the first cohort (discussed above with regard to FIG. 1A), a risk migration for the high risk category (dP_{H}) may be determined to be −0.2%, a risk migration for a medium risk category (dP_{M}) may be determined to be −4.2%, and a risk migration for a low risk category (dP_{L}) may be determined to be 4.4%. In accordance with the population health risk profiles 102b and 104b for the second cohort (discussed above with regard to FIG. 1B), a risk migration for the high risk category (dP_{H}) may be determined to be −5.9%, a risk migration for a medium risk category (dP_{M}) may be determined to be −0.1%, and a risk migration for a low risk category (dP_{L}) may be determined to be 6.2%.

In some embodiments, a risk migration for a category is normalized based on the time span associated with the corresponding cohort data. For example, where the first cohort is associated with a time span of 2 years, the risk migration for the categories of the first cohort may be normalized to a base of 1 year by dividing the risk migration by 2. That is, a normalized risk migration for the high risk category (dP_{H}/dt) of the first cohort may be determined to be −0.1% per year, a normalized risk migration for the medium risk category (dP_{M}/dt) of the first cohort may be determined to be −2.1% per year, and a normalized risk migration for a low risk category (dP_{L}/dt) may be determined to be 2.2% per year. Similarly, for example, where the second cohort is associated with a time span of 6 years, the risk migration for the categories of the second cohort may be normalized to a base of 1 year by dividing the risk migration by 6. That is, a normalized risk migration for the high risk category (dP_{H}/dt) of the second cohort may be determined to be −1.0% per year, a normalized risk migration for a medium risk category (dP_{M}/dt) of the second cohort may be determined to be −0.02% per year, and a normalized risk migration for a low risk category (dP_{L}/dt) of the second cohort may be determined to be 1.05% per year.

In some embodiments, a risk migration for a category is an average of the normalized risk migrations for the category of the cohorts being considered. For example, in the above example, where normalized risk migration for the high risk category (dP_{H}/dt) of the first cohort is determined to be −0.1% per year and the normalized risk migration for the high risk category (dP_{H}/dt) of the second cohort is be determined to be −1.0% per year, the normalized risk migration for the high risk category (dP_{H}/dt) may be determined to be −0.55% per year (e.g., −0.55% per year=(−0.1% per year+−1.0% per year)/2). Using similar techniques, the normalized risk migration for the medium risk category (dP_{M}/dt) may be determined to be −1.06% per year and the normalized risk migration for the low risk category (dP_{L}/dt) may be determined to be 1.63% per year.

In some embodiments, a risk number for a category is a number of risks associated with the given category. For example, where the high, medium and low risk categories for the first and second cohorts are associated with 5 risks, 3.5 risks and 1 risks, respectively, R_{H} for the first cohort may be determined to be 5 risks, R_{L} for the first cohort may be determined to be 3.5 risks, and R_{L} for the first cohort may be determined to be 1 risks.

In some embodiments, the later portion of equation (1) (reproduced below as equation (2)) represents an average number of risk avoided per participant in the workplace wellness program:

$$\frac{d {P}_{L}}{d t} {R}_{L} + \frac{d {P}_{M}}{d t} {R}_{M} + \frac{d {P}_{H}}{d t} {R}_{H} \qquad ( 2 )$$

Accordingly, in some embodiments, an average number of risks avoided per participant in a wellness program may be determined based on the normalized versions of the risks migrations and the risk numbers. In accordance with the examples discussed above, (e.g., where dP_{H}/dt=−0.55% per year, dP_{M}/dt=−1.06% per year, dP_{L}/dt=1.63% per year, R_{H}=5, R_{M}=3.5 and R_{L}=1) an average change in risk avoided may be determined to be −4.1% per year (e.g., −4.1%=(−0.55% per year*5 risks)+(−1.06% per year*3.5 risks)+(1.63% per year*1 risk)), or an average of about 0.041 risk avoided per participant per year.

In some embodiments, the total population value (ψ) represents a total number of participants impacted by (or subject to) the workplace wellness program. For example, where 10,000 employees currently participate in a workplace wellness program, the total population value (ψ) for the workplace wellness program may be determined to be 10,000.

In some embodiments, a total number of risks avoided that are attributable to a workplace wellness program can be determined as a product of the total population value (ψ) for the workplace wellness program and the average number of risk avoided per participant per year. In accordance with the above example, a total number of risks avoided that are attributable to the workplace wellness program may be determined to be approximately 410 (e.g., 401 risks avoided per year=10,000 participants*0.041 risk avoided per participant per year).

In some embodiments, a direct cost avoided that is attributable to a workplace wellness program can be determined as a product of the total number of risk avoided per year and a direct cost associated with a health risk. In accordance with the above example, a direct cost avoided that is attributed to the workplace wellness program may be determined to be approximately $616,230 per year (e.g., $616,230 direct cost per year=$1503 direct cost per risk*410 risk avoided per year).

In some embodiments, a total cost avoided that is attributable to a workplace wellness program can be determined as a product of the direct cost avoided and the cost relationship constant. In accordance with the above example, a total cost avoided that is attributable to the workplace wellness program may be determined to be approximately $2,896,281—per year (e.g., $2,896,281 total cost avoided per year=$616,230—direct cost per year*4.7 total cost/direct cost). As noted above, the total cost avoided may be referred to as the “presenteeism value” of the workplace wellness program. That is, the workplace wellness program may be said to have a presenteeism value of $2,896,281—per year. In some embodiments, the presenteeism value may include something other than a monetary/dollar value. For example, where a barrel of oil has a market value of $107, the presenteeism value for a workplace wellness program may be expressed as 27,068 barrels of oil per year (e.g., 25,861 barrels of oil per year=$2,896,281 per year/$107 per barrel). In some embodiments, presenteeism value is normalized based on population size to provide a rate of return per employee. For example, where 10,000 employees participate in the workplace wellness program, the normalized presenteeism value for may be determined to be $290 per employee per year ($290 per employee per year=$2,896,281 per year/10,000 employees). Such a presenteeism value may enable an organization to better understand the impact of a workplace wellness program in the context of their business. For example, an oil company may be able to easily relate the figure of 27,068 barrels of oil per year to their business costs and specific costs and benefits of other programs within the organization.

In certain embodiments, the wellness system updates a workplace wellness program based on a presenteeism value. For example, where a first version of a workplace wellness program has a presenteeism value of $1,000,000 per year, and a second version of a workplace wellness program has a less positive impact over a second time period (e.g., has a presenteeism value of less than $100,000 per year) the wellness system may automatically update the workplace wellness program to include features of the first version of the workplace wellness program. That is, the wellness system may update the workplace wellness program to revert to features of the first version of the workplace wellness program in hopes of increasing savings to the levels of the prior version of the workplace wellness program.

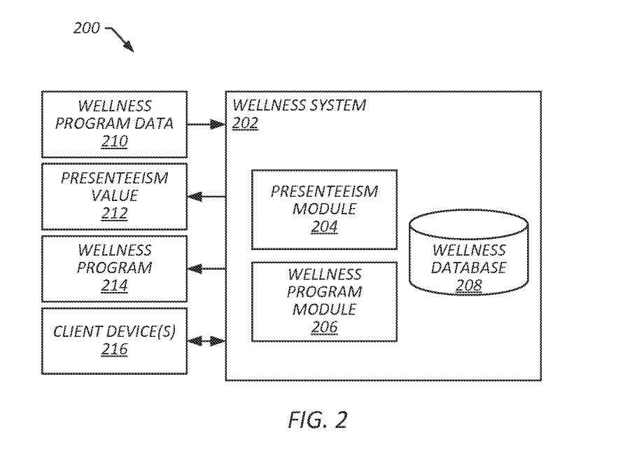

FIG. 2 is a diagram that illustrates a wellness environment 200 in accordance with one more embodiments of the present invention. In some embodiments, wellness environment 200 includes a wellness system 202. Wellness system 202 may include a presenteeism module 204, a wellness program module 206 and a wellness database 208. In some embodiments, wellness system 202 may provide for the implementation and monitoring of various aspect of a workplace wellness program 214. Workplace wellness program 214 may include modified/updated policies, instructions, programs or the like that can be implemented by an organization. For example, presenteeism module 204 may receive and use wellness program data 210 to determine a presenteeism value 212 for a workplace wellness program 214. In some embodiments, wellness program module 206 monitors and/or implements various aspects of a workplace wellness program. For example, wellness program module 206 may generate a modified/updated version of workplace wellness program 214 based on presenteeism value 212. Wellness program data 210, presenteesim value 212 and/0r workplace wellness program 214 may be stored in wellness database 208 (or another data repository).

Wellness environment 200 may include one or more client devices 216. In some embodiments, a client device 216 may include a computer or similar device for collecting wellness program data and/or providing feedback regarding a workplace wellness program. For example, client device 216 may include a health data collection computer that is adapted to receive wellness program data 210, and/or to forward wellness program data 210 to wellness system 202 for use by presenteeism module 204 and/or wellness program module 206. In some embodiments, client device 216 may be employed a workplace wellness program participant to provide data regarding their health and/or health care personnel (e.g., a wellness program provider) to provide data regarding the health of one or more workplace wellness program participants. For example, an employee or health personnel may enter and submit health information (e.g., wellness program data 210) via device 216. Client device 216 may include a health data output computer that is adapted to receive and display information about wellness program 214. For example, client device 216 may receive and display, to a workplace wellness program participant or health care personnel, workplace wellness program content pages that include information about the workplace wellness program, such as current workplace wellness program statistics, policies, instructions, programs and the like for the workplace wellness program.

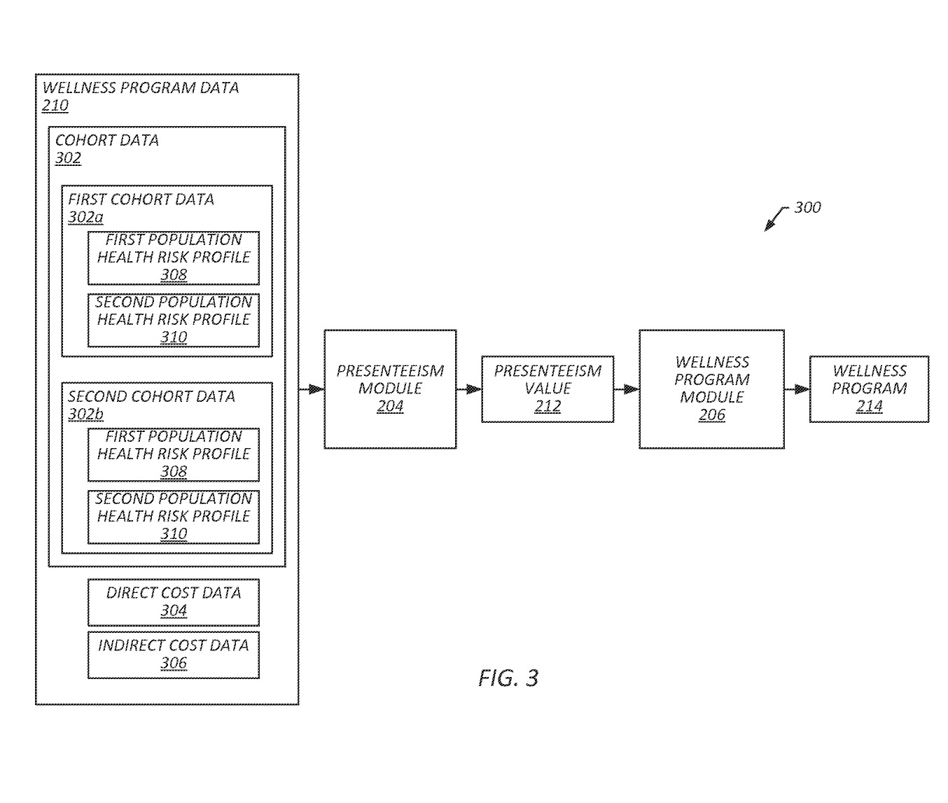

FIG. 3 is a flow diagram 300 that illustrates operations of wellness system 202 in accordance with one more embodiments of the present invention. In some embodiments, wellness program data 210 is provided to presenteeism module 204. Wellness program data 210 may include data related to workplace wellness program 214. Wellness program data 210 may include data obtained from participants in the workplace wellness program 214 (e.g., via medical/health screenings, surveys, and/or the like) and/or data obtained as a result of studies that are relevant to workplace wellness program 214 (e.g., studies of direct/indirect costs relationships).

In some embodiments, wellness program data 210 includes cohort data 302 corresponding to one or more cohorts participating in workplace wellness program 214. For example, wellness program data 210 may include first cohort data 302a for a first group of employees (e.g., 6,366 employees) subject to workplace wellness plan 214 over a first time span (e.g., 2007-2009) and second cohort data 302b for a second cohort data 302 for a second group of employees (e.g., 1,157 employees) subject to the workplace wellness plan for a second time span (e.g., 2005-2011). Although certain embodiments are described herein with regard to two cohorts for the purpose of illustration, embodiments may include employing wellness program data from any number of cohorts (e.g., one, two, three, four cohorts or the like).

In some embodiments, cohort data 302 includes entry and exit data for the cohort(s). For example, first cohort data 302a may include a first/entry population health risk profile 308 corresponding to characteristics of the first cohort on or about Jan. 1, 2007 and a second/exit population health risk profile 310 corresponding to characteristics of the first cohort on or about Jan. 1, 2009. A population health risk profile for a cohort may be indicative of a distribution of the population into various health risk categories. For example, a first/entry population health risk profile may correspond to characteristics of a cohort on or about a start of a timespan corresponding to the cohort. A second/exit population health risk profile may correspond to characteristics of a cohort on or about an end of a timespan corresponding to the cohort. For example, first/entry population health risk profile 308 of first cohort data 302 may correspond to first/entry population health risk profile 102a of FIG. 1. First/entry population health risk profile 308 of first cohort data 302 and may specify that 152 participants in the first cohort (e.g., 2.4% of the cohort group's population) are categorized as high risk, that 2,483 participants in the first cohort (e.g., 39% of the cohort group's population) are categorized as medium risk, and that 3731 participants in the first cohort (e.g., 58.6% of the cohort group's population) are categorized as low risk on or about Jan. 1, 2007. Second/exit population health risk profile 310 of first cohort data 302 may correspond to second/exit population health risk profile 104a of FIG. 1. Second/exit population health risk profile 310 of first cohort data 302 may specify that 89 participants in the first cohort (e.g., 2.2% of the cohort group's population) are categorized as high risk, that 2199 participants in the second cohort (e.g., 34.8% of the cohort group's population) are categorized as medium risk, and that 4078 participants in the second cohort (e.g., 63% of the cohort group's population) are categorized as low risk on or about Jan. 1, 2009. First/entry population health risk profile 308 of second cohort data 302b may correspond to first/entry population health risk profile 102b of FIG. 1, and second/exit population health risk profile 310 of second cohort data 302b may correspond to second/exit population profile 104b, and thus, may each provide population health risk profile information for characteristics of the second cohort on or about Jan. 1, 2005 and Jan. 1, 2011, respectively.

In some embodiments, direct cost data 304 is indicative of direct costs, such as medical costs, associated with a risk. For example, direct cost data 304 may include a specified medical cost of $1503 per risk (MCPR). In some embodiments, direct cost data 304 includes medical costs associated with multiple risks that can be used to determine a medical cost per risk. For example, direct cost data 304 may include a listing of medical cost of $1616 for Body Mass Index (BMI) risks, $876 Blood Pressure (Pre HTN) risks, $950 Blood Pressure (HTN) risks, $961 Physical Activity risks, $965 Tobacco risks, $2533 Musculoskeletal (Low Back Pain) risks, $1870 Musculoskeletal (Shoulder Pain) risks and $1718 for Stress risks. These medical costs per risk can be averaged to determine an average medical cost per risk (e.g., an average medical cost per risk of $1503).

In some embodiments, indirect cost data 306 is indicative of a ratio of indirect costs to direct costs associated with a health risk. In some embodiments, indirect cost data 306 specifies or is otherwise indicative of a cost ratio of about 4:1 that is indicative a ratio of about $4 in indirect cost being attributable to a health risk for every $1 of direct costs attributable to a health risk. For example, indirect cost data 306 may specify a cost ratio of 3.7:1. Such a ratio may be indicative of a $3.7 of indirect costs for every $1 of direct costs associated with a health risk. Thus, for example, a total of $4.7 of total costs may be saved for every $1 of direct costs avoided.

In some embodiments, presenteeism module 204 receives wellness program data 210 and determines presenteeism value 212 for workplace wellness program 214 based at least in part on wellness program data 210. In some embodiments, a presenteeism module 204 employs the presenteeism algorithm of equation (1) to determine presenteeism value 212 for workplace wellness program 214. Thus, for example, presenteeism module 204 may determine a presenteeism value of $2,896,281 per year for workplace wellness program 214 based on application of equation (1) to wellness program data 210 as described herein. In some embodiments, presenteeism module 204 may express presenteeism value 212 in something other than a monetary/dollar value. For example, where a barrel of oil has a market value of $107, presenteeism module 204 may output a presenteeism value 27,068 barrels of oil per year (e.g., 27,068 barrels of oil per year=$2,896,281 per year/$107 per barrel).

In some embodiments, wellness program module 206 modifies/updates workplace wellness program 214 based on presenteeism value 212. For example, where a first version of a workplace wellness program 214 has a positive impact over a first time period (e.g., has a presenteeism value of $1,000,000 per year), and a second version of a workplace wellness program has a less positive impact over a second time period (e.g., has a presenteeism value of $100,000 per year), the wellness program module 206 may automatically update workplace wellness program 214 to include features of the first version of workplace wellness program 214. That is, for example, wellness program module 206 may generate a third/modified/updated version of workplace wellness program 214 that includes reversions to some or all of the features of the first version of workplace wellness program 214. Such an updated workplace wellness program 214 may include modified/updated policies, instructions, programs or the like that can be implemented by the organization.

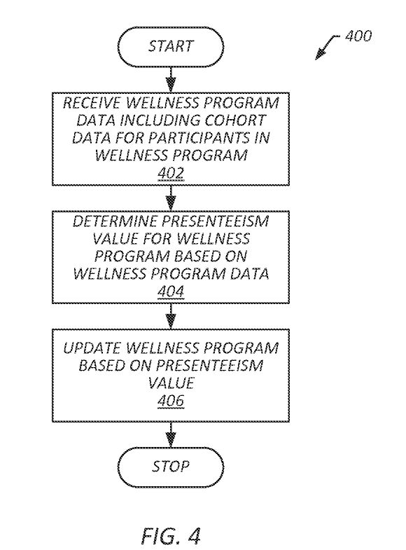

FIG. 4 is a flowchart that illustrates a method 400 of assessing a wellness program in accordance with one or more embodiments of the present invention. Method 400 generally includes receiving wellness program data (including cohort data for participants in a wellness program) (block 402), determining a presenteeism value for the wellness program based on the wellness program data (block 404), and generating an updated version of the wellness program based on the presenteeism value (block 406).

In some embodiments, receiving wellness program data including cohort data for participants in wellness program (block 402) includes receiving wellness program data 210. For example, presenteeism module 204 may retrieve wellness program data 210 from wellness database 208, or otherwise receive wellness program data 210.

In some embodiments, determining presenteeism value for wellness program based on wellness program data (block 404) includes determining presenteeism value 212 for wellness program 214 based at least in part on wellness program data 210. For example, presenteeism module 204 may employ wellness program data 210 to determine presenteeism value 212 as described herein.

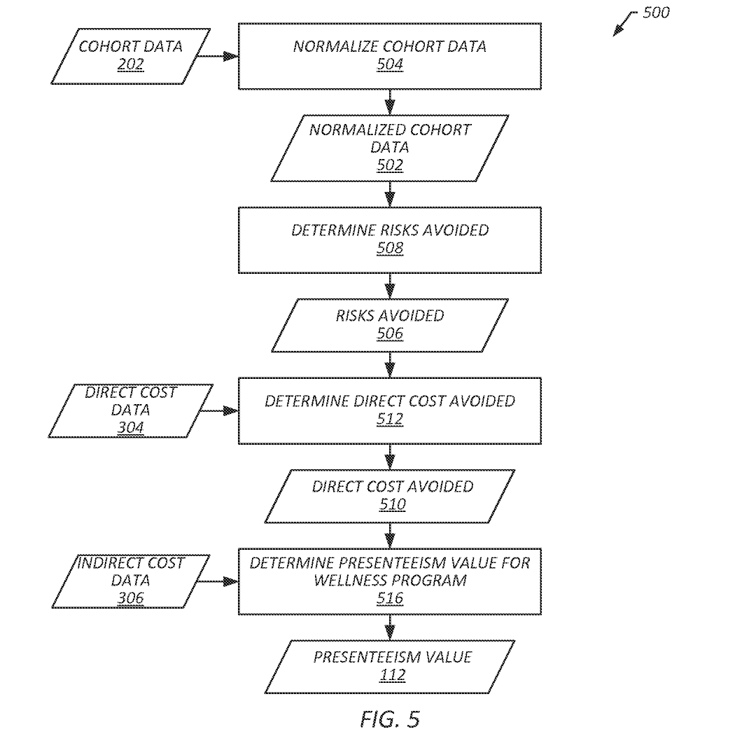

FIG. 5 is a flowchart that illustrates a method 500 of determining a presenteeism value in accordance with one or more embodiments of the present invention. Method 500 generally includes normalizing cohort data to generate normalized cohort data 502 (block 504), determining risks avoided 506 (block 508), determining direct cost avoided 510 (block 512), and determining a presenteeism value 112 for the wellness program (block 516). In some embodiments, presenteeism module 204 implements some or all of the aspects of method 500 to determine presenteeism value 212. In some embodiments, method 500 provides for calculation of a presenteeism value in accordance with equation (1) as described herein.

In some embodiments, normalizing cohort data (block 504) includes normalizing risk migrations for corresponding cohort data. For example, where a population profile includes three risk categories (e.g., low, medium and high risk categories), risk migrations (dP) for each category may be determined based on a difference in the number of participants in each of the categories at the start and end times for the corresponding time span as indicated by the respective population health risk profiles. In some embodiments, the risk migration includes a percentage change in the number of participants in the given category. In accordance with the population health risk profiles 308 and 310 of first cohort data 302a (e.g., corresponding to population health risk profiles 102a and 104a of FIG. 1A), a risk migration for the high risk category (dP_{H}) may be determined to be −0.2%, a risk migration for a medium risk category (dP_{M}) may be determined to be −4.2%, and a risk migration for a low risk category (dP_{L}) may be determined to be 4.4%. In accordance with the population health risk profiles 308 and 310 of second cohort data 302b (e.g., corresponding to population health risk profiles 102b and 104b of FIG. 1B), a risk migration for the high risk category (dP_{H}) may be determined to be −5.9%, a risk migration for a medium risk category (dP_{M}) may be determined to be −0.1%, and a risk migration for a low risk category (dP_{L}) may be determined to be 6.2%.

In some embodiments, normalizing cohort data (block 504) includes normalizing a risk migration for a category based on the time span associated with the corresponding cohort data. For example, where first cohort data 302a is associated with a time span of 2 years, the risk migration for the categories of the first cohort may be normalized to a base of 1 year by dividing the risk migration by 2. That is, a normalized risk migration for the high risk category (dP_{H}/dt) of the first cohort may be determined to be −0.1% per year, a normalized risk migration for the medium risk category (dP_{M}/dt) of the first cohort may be determined to be −2.1% per year, and a normalized risk migration for a low risk category (dP_{L}/dt) may be determined to be 2.2% per year. Similarly, for example, where second cohort data 302b is associated with a time span of 6 years, the risk migration for the categories of the second cohort may be normalized to a base of 1 year by dividing the risk migration by 6. That is, a normalized risk migration for the high risk category (dP_{H}/dt) of the second cohort may be determined to be −1.0% per year, a normalized risk migration for a medium risk category (dP_{M}/dt) of the second cohort may be determined to be −0.02% per year, and a normalized risk migration for a low risk category (dP_{L}/dt) of the second cohort may be determined to be 1.05% per year.

In some embodiments, normalizing cohort data (block 504) includes averaging the normalized risk migrations for a category in each cohort to generate a risk migration for the category. For example, in the above example, where normalized risk migration for the high risk category (dP_{H}/dt) of first cohort data 302a is determined to be −0.1% per year and the normalized risk migration for the high risk category (dP_{H}/dt) of second cohort data 302b is determined to be −1.0% per year, the normalized risk migration for the high risk category (dP_{H}/dt) may be determined to be −0.55% per year (e.g., −0.55% per year=(−0.1% per year+−1.0% per year)/2). Using similar techniques, the normalized risk migration for the medium risk category (dP_{M}/dt) may be determined to be −1.06% per year and the normalized risk migration for the low risk category (dP_{L}/dt) may be determined to be 1.63% per year.

In some embodiments, determining risks avoided (block 508) includes determining a number of risks associated with the given category. For example, where the high, medium and low risk categories for the first and second cohort data 302a and 302b are associated with 5 risks, 3.5 risks per year and 1 risks per year, respectively, R_{H} may be determined to be 5 risks, R_{L} may be determined to be 3.5 risks per year, and R_{L} may be determined to be 1 risks.

In some embodiments, determining risks avoided (block 508) includes determining an average number of risks avoided per participant in the workplace wellness program. In some embodiments, an average number of risks avoided per participant in the wellness program may be determined based on the normalized versions of the risks migrations and the risk numbers. In accordance with the examples discussed above, (e.g., where dP_{H}/dt=−0.55%, dP_{M}/dt=−1.06%, dP₁/dt=1.63%, R_{H}=5, R_{M}=3.5 and R_{L}=1) an average change in risk avoided may be determined to be −4.1% per year (e.g., −4.1%=(−0.55% per year*5 risks)+(−1.06% per year*3.5 risks)+(1.63% per year*1 risk)), or an average of about 0.041 risk avoided per participant per year.

In some embodiments, determining risks avoided (block 508) includes determining a total number of risks avoided. In some embodiments, a total number of risks avoided that are attributable to a workplace wellness program is determined as a product of the total population value (ψ) for the workplace wellness program (e.g., 10,000 participants) and the average number of risk avoided per participant per year (e.g., 0.041 risk avoided per participant per year). In accordance with the above example, a total number of risks avoided that are attributable to workplace wellness program 214 may be determined to be approximately 410 (e.g., 401 risks avoided per year=10,000 participants*0.041 risk avoided per participant per year).

In some embodiments, determining direct cost avoided 510 (block 512) includes determining total medical claim cost avoided that is attributed to workplace wellness program 214. In some embodiments, a total medical claim cost avoided that is attributable to a workplace wellness program can be determined as a product of the total number of risk avoided per year and direct cost associated with a health risk. In accordance with the above example, a direct cost avoided that is attributable to workplace wellness program 214 may be determined to be approximately $616,230 per year (e.g., $616,230 direct cost per year=$1503 direct cost per risk*410 risk avoided per year).

In some embodiments, determining a presenteeism value 112 for the wellness program (block 516) includes determining a total cost avoided that is attributable to a workplace wellness program. A total cost avoided that is attributed to a workplace wellness program can be determined as a product of the direct cost avoided and the cost relationship constant. In accordance with the above example, a total cost avoided that is attributed to workplace wellness program 214 may be determined to be approximately $2,896,281 per year (e.g., $2,896,281 total cost avoided per year=$616,230 588,760 direct cost per year*4.7 total cost/direct cost). As noted above, the total cost avoided may be referred to as the “presenteeism value” of the workplace wellness program. That is, workplace wellness program 214 may be said to have a presenteeism value of $2,896,281 per year. In some embodiments, the presenteeism value may include something other than a monetary/dollar value. For example, where a barrel of oil has a market value of $107, the presenteeism value of workplace wellness program 214 may be expressed as 27,068 barrels of oil per year (e.g., 27,068 barrels of oil per year=$2,896,281 per year/$107 per barrel). Such a presenteeism value may enable an organization to better understand the impact of a workplace wellness program in the context of their business. For example, an oil company may be able to easily relate the figure of 27,068 barrels of oil per year to their business costs and specific costs and benefits of other programs within the organization. In some embodiments, presenteeism value 212 is stored and/or provided to other entities of environment 200. For example, presenteeism module 204 may store presenteeism value 212 in wellness database 208 and/or provided presenteeism value 212 to wellness program module 206. In some embodiments, presenteeism value is normalized based on population size to provide a rate of return per employee. For example, where 10,000 employees participate in workplace wellness program 214, the normalized presenteeism value for may be determined to be $290 per employee per year ($290 per employee per year=$2,896,281 per year/10,000 employees).

In some embodiments, generating an updated version of the wellness program based on the presenteeism value (block 406) includes generating a current/modified/updated version of workplace wellness program 214 based on presenteeism value 214. For example, wellness program module 206 may employ presenteeism value 214 to determine whether workplace wellness program 214 should be updated, may make appropriate adjustments to workplace wellness program 214, and may provide a current/modified/updated version of workplace wellness program 214 for use by the organization and its employees.

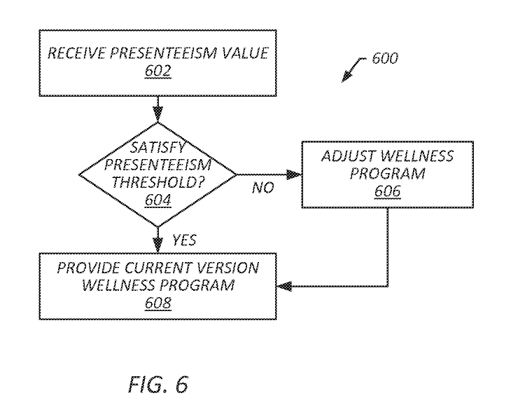

FIG. 6 is a flowchart that illustrates a method 600 of adjusting a wellness program in accordance with one or more embodiments of the present invention. Method 600 generally includes receiving a presenteeism value (block 602), determining whether the presenteeism value received satisfies a presenteeism threshold value (block 604), and, if the presenteeism value does satisfy the presenteeism value threshold, providing the wellness program (block 608), or, if the presenteeism value does not satisfy the presenteeism value threshold, updating the wellness program (block 606) and providing the current version of the wellness program (block 608). In some embodiments, wellness program module 206 implements some or all of the aspects of method 600 to generate or otherwise provide wellness program 214.

In some embodiments, receiving a presenteeism value (block 602) includes receiving presenteeism value 212. For example, wellness program module 206 may receive presenteeism value 212 from presenteeism module 204, may retrieve presenteeism value 212 from wellness database 208, or otherwise receive presenteeism value 212.

In some embodiments, determining whether the presenteeism value received satisfies a presenteeism threshold value (block 604) includes comparing the presenteeism value to a presenteeism threshold value. In some embodiments, a presenteeism threshold value is a predetermined value, such as $200 per employee per year. In some embodiments, a presenteeism threshold value is based on a prior presenteeism value. The presenteeism threshold value may be equal to a previously calculated presenteeism value. For example, the presenteeism threshold value may be equal to a presenteeism value for the workplace wellness program calculated one year ago in the same manner via an annual evaluation of the workplace wellness program. The presenteeism threshold value may be proportionate to a previously calculated presenteeism value. For example, the presenteeism threshold value may be equal to 90% of a presenteeism value for the workplace wellness program calculated one year ago in the same manner via an annual evaluation of the workplace wellness program.

In some embodiments, the wellness program 214 is adjusted if it determined that the presenteeism value does not satisfy the presenteeism threshold value (block 604). For example, where the presenteeism threshold value is $300 per employee per year and the presenteeism value for workplace wellness program 214 is $290 per employee per year, one or more elements of workplace wellness program 214 may be automatically adjusted (e.g., without human intervention). For example, a policy of workplace wellness program 214 that requires bi-annual employee health evaluations may be modified to require monthly employee health evaluations. In some embodiments, the workplace wellness program 214 is modified to include characteristics of workplace wellness programs that are associated with higher presenteeism values. For example, if the version of the workplace wellness program 214 implemented prior to the current version of the workplace wellness program 214 included bi-weekly employee exercise classes and had a presenteeism value of $300 per employee per year and the current version of the workplace wellness program 214 includes only weekly employee exercise classes and has a presenteeism value of $290 per employee per year, adjusting workplace wellness program 214 may include generating a current version of workplace wellness program 214 that includes bi-weekly employee exercise classes. That is, adjusting may include incorporating features of other workplace wellness programs having a higher presenteeism value. The current (or now modified/updated) version of workplace wellness program 214 may be provided (block 608). For example, a company's workplace wellness policies may be updated to reflect offering of bi-weekly employee exercise classes. In some embodiments, information relates to a workplace wellness program characteristics (e.g., workplace wellness program statistics, updated policies and the like) may be presented to a user via a workplace wellness program content page (e.g., webpage) or similar application interface.

In some embodiments, the wellness program is not adjusted if it determined that the presenteeism value received does satisfy a presenteeism threshold value (block 604). For example, where the presenteeism threshold value is $200 per employee per year and the presenteeism value for workplace wellness program 214 is $290 workplace wellness program 214 may not be automatically adjusted, and the current version of workplace wellness program 214 may be provided (block 608). In such an embodiment, the current version of workplace wellness program 214 may be the same or substantially similar to the version of workplace wellness program 214 for which the presenteeism value was determined.

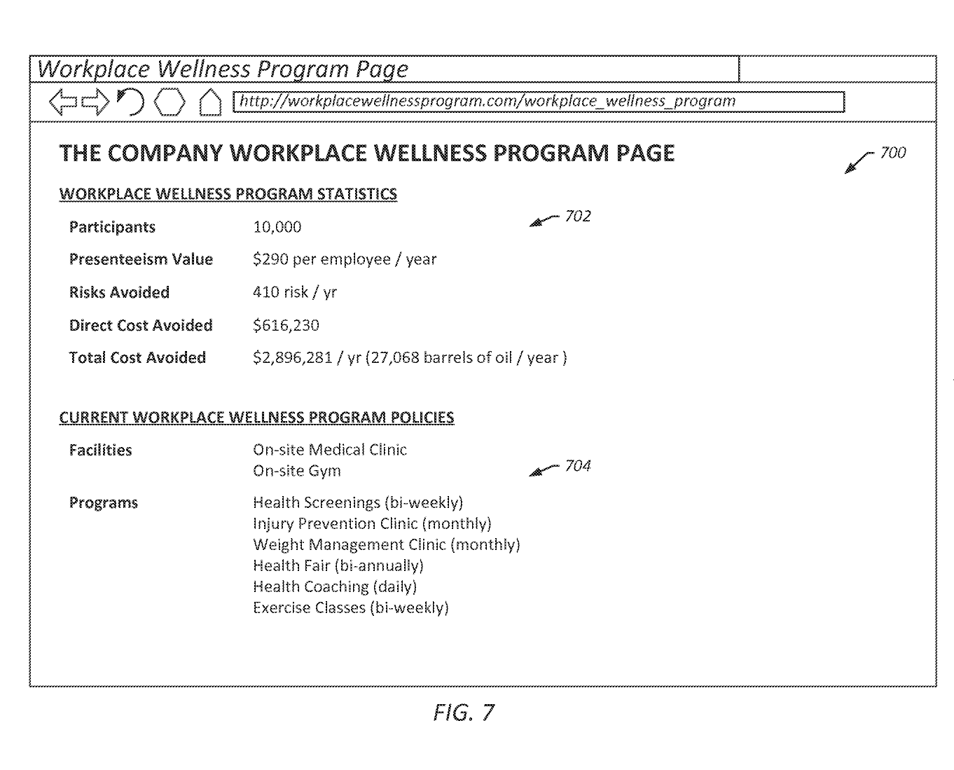

FIG. 7 illustrates an exemplary workplace wellness program page 700 in accordance with one or more embodiments of the present invention. In some embodiments, workplace wellness program page 700 is provided to one or more client devices by wellness program module 206. For example, workplace wellness program page 700 may include a network content page, such as a webpage or other application page, that is served to one or more client devices 216 by wellness program module 206 and/or rendered for display to user by the one or more client device 216. In the illustrated embodiment, workplace wellness program page 700 includes workplace wellness program statistics 702. Workplace wellness program statistics 702 may include, for example, a number of participants in the workplace wellness program, the determined presenteeism value for the workplace wellness program, a number of risks avoided, a direct cost avoided, a total cost avoided, and/or the like. In the illustrated embodiment, workplace wellness program page 700 includes workplace wellness program policies 704. Workplace wellness program policies 704 may include, for example, information regarding facilities and programs that are available under the workplace wellness program. In the illustrated embodiment, workplace wellness program page 700 indicates bi-weekly employee exercise classes, and thus, may reflect a modified/updated version of the workplace wellness program 214 that was modified to include bi-weekly employee exercise classes as discussed herein.

Accordingly, in some embodiments of the present invention, an impact of a workplace wellness program may be quantified, e.g., via a presenteeism value determined based on equation (1). In some embodiments, the quantified impact of the workplace wellness program can be used as a metric to justify cost associated with implementing the workplace wellness program. In some embodiments, the quantified impact of the workplace wellness program can be used to assess the effectiveness of the workplace wellness program, and/or can be used as a basis for adjusting various aspects of the workplace wellness program, e.g., to adjust workplace wellness program policies in an effort to improve the rate of return for a workplace wellness program.

It will be appreciated that methods 400, 500 and 600 are exemplary embodiments of methods that may be employed in accordance with techniques described herein. The methods 400, 500 and 600 may be may be modified to facilitate variations of its implementations and uses. The order of the methods 400, 500 and 600 and the operations provided therein may be changed, and various elements may be added, reordered, combined, omitted, modified, etc. The methods 400, 500 and 600 may be implemented in software, hardware, or a combination thereof. Some or all of methods 400, 500 and 600 may be may be implemented by one or more of the modules/applications described herein and/or may be executed on one or more devices. For example, presenteeism module 202 and/or wellness program module 204 may be employed on a single computer/server or multiple computers/servers.

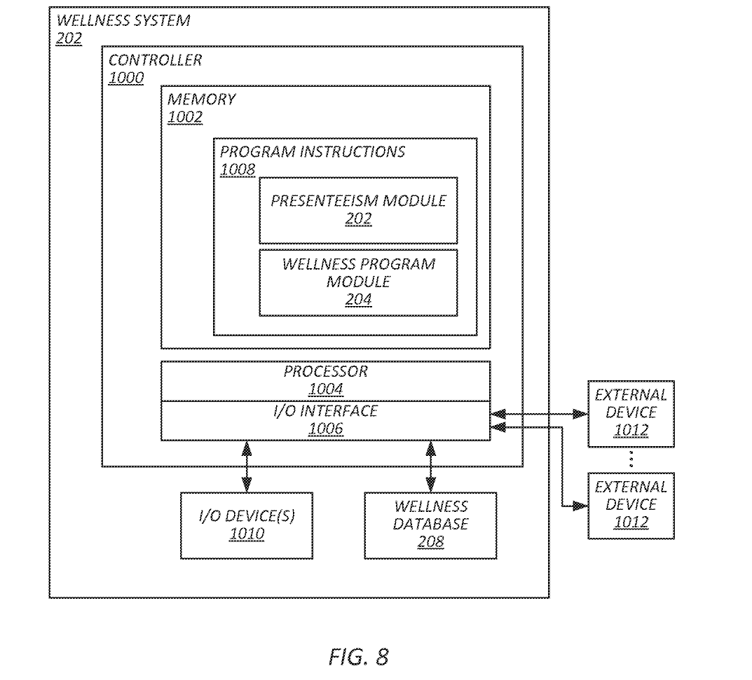

FIG. 8 is a block diagram that illustrates components of wellness system 202 in accordance with one or more embodiments of the present invention. In some embodiments, wellness system 202 includes a controller 1000 for controlling the operational aspects of wellness system 202. In some embodiments, controller 1000 includes a memory 1002, a processor 1004 and an input/output (I/O) interface 1006. Memory 1002 may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. Memory 1002 may include a non-transitory computer readable storage medium having program instructions 1008 stored thereon that are executable by a computer processor (e.g., processor 1004) to cause the functional operations (e.g., methods/routines/processes) described herein with regard to wellness system 202. Program instructions 1008 may include program instructions modules that are executable by processor 1004 to provide some or all of the functionality described herein with regard to credential wellness system 202. Program instructions 1008 may include a presenteeism module 202 and/or wellness program module 204 for performing some or all of the operational aspects of methods 400, 500 and/or 600.

Processor 1004 may be any suitable processor(s) capable of executing/performing program instructions. Processor 1004 may include a central processing unit (CPU) that carries out program instructions (e.g., program instructions of modules 202 and/or 204) to perform arithmetical, logical, and input/output operations of wellness system 202, including those described herein. I/O interface 1006 may provide an interface for communication with of one or more I/O devices, wellness database 208, and/or external devices 1012. I/O devices may include a keyboard, a graphical user interface, a microphone, a speaker, and/or the like. External devices 1012 may include network servers, user devices, external databases (e.g., an external wellness database), and/or the like. External devices 1012 may include servers, computers or the like. External devices 1012 may include one or more client devices 216. I/O devices and external devices may be connected to I/O interface 1006 via a wired or wireless connection (e.g., via network 106).

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A workplace wellness program system comprising:
a wellness database configured to store workplace wellness program data, the workplace wellness program data comprising:
cohort health risk data for one or more cohort groups subject to the workplace wellness program, the cohort health risk data for each cohort group comprising:
an entry population health risk profile indicative of health risk categorizations for employees in the cohort group at a start of a time span associated with the cohort group; and
an exit population health risk profile indicative of health risk categorizations for the employees in the cohort group at an end of the time span associated with the cohort group;
direct cost data indicative of an average medical cost associated with a health risk; and
total cost data indicative of a ratio of total cost avoided to medical cost avoided;
a presenteeism module configured to:
receive the workplace wellness program data;
determine a number of employees subject to the workplace wellness program;
normalize the cohort health risk data for the one or more cohort groups to generate a normalized number of risk avoided per employee for a given duration of time;
determine an average medical cost associated with a health risk based at least in part on the direct cost data;
determine a ratio of total cost avoided to medical cost avoided based at least in part on the total cost data; and
determine a presenteeism value indicative of a total cost avoided over the given duration of time based at least in part on a product of the normalized number of risk avoided per employee for the given duration of time, the number of employees subject to the workplace wellness program, the average medical cost associated with a health risk and the ratio of total cost avoided to medical cost avoided; and
a wellness program module configured to:
receive the presenteeism value from the presenteeism module;
determine whether the presenteeism value satisfies a presenteeism value threshold; and
in response to determining that the presenteeism value does not satisfy the presenteeism value threshold:
generate a modified version of the workplace wellness program; and
serve, to a client device for display, a workplace wellness program content page comprising information regarding the modified version of the workplace wellness program.

2. The system of claim 1, wherein normalizing the cohort health risk data for the one or more cohort groups to generate a normalized number of risk avoided per employee for a given duration of time comprises:
for each of the one or more cohort groups, determining a rate of risk avoidance for the given duration of time based at least in part on shifts in health risks categorizations between the entry population health risk profile and the second population health risk profile; and
averaging the rates of risk avoidance for the one or more cohort groups to generate the normalized number of risk avoided per employee for the given duration of time.

3. A workplace wellness program system for quantifying an impact of a workplace wellness program, the system comprising:
one or more processors; and
one more memories storing program instructions that are executable by the one more processors to cause the following steps:
receive workplace wellness program data comprising:
cohort health risk data for one or more cohort groups subject to the workplace wellness program, the cohort health risk data for each cohort group comprising:
a first population health risk profile indicative of health risk categorizations for employees in the cohort group at a start of a time span associated with the cohort group; and
a second population health risk profile indicative of health risk categorizations for the employees in the cohort group at an end of the time span associated with the cohort group;
direct cost data indicative of an average direct cost associated with a health risk; and
total cost data indicative of a ratio of total cost avoided to direct cost avoided;
determine a number of employees subject to the workplace wellness program;
normalize the cohort health risk data for the one or more cohort groups to generate a normalized number of risk avoided per employee for a given duration of time;
determine an average direct cost associated with a health risk based at least in part on the direct cost data;
determine a ratio of total cost avoided to direct cost avoided based at least in part on the total cost data; and
determine a presenteeism value indicative of a total cost avoided over the given duration of time based at least in part on a product of the normalized number of risk avoided per employee for the given duration of time, the number of employees subject to the workplace wellness program, the average direct cost associated with a health risk and the ratio of total cost avoided to direct cost avoided.

4. The system of claim 3, wherein normalizing the cohort health risk data for the one or more cohort groups to generate a normalized number of risk avoided per employee for a given duration of time comprises:
for each of the one or more cohort groups, determining a rate of risk avoidance for the given duration of time based at least in part on shifts in health risks categorizations between the first population health risk profile and the second population health risk profile; and
averaging the rates of risk avoidance for the one or more cohort groups to generate the normalized number of risk avoided per employee for the given duration of time.

5. The system of claim 3, the steps further comprising determining an estimated number of risks avoided based at least in part on a product of the normalized number of risk avoided and the number of employees subject to the workplace wellness program.

6. The system of claim 3, the steps further comprising determining a direct cost avoided based at least in part on a product of the average direct cost associated with a health risk and the estimated number of risks avoided.

7. The system of claim 3, the steps further comprising determining an indirect cost avoided based at least in part on a product of the average direct cost avoided and the ratio of indirect cost to direct cost.

8. The system of claim 3, the steps further comprising generating a modified version of the workplace wellness program based at least in part on the presenteeism value.

9. The system of claim 3, the steps further comprising:
determining whether the presenteeism value satisfies a presenteeism value threshold; and
in response to determining that the presenteeism value does not satisfy the presenteeism value threshold:
generating a modified version of the workplace wellness program; and
providing for display of a workplace wellness program content page comprising information regarding the modified version of the workplace wellness program.

10. A computer-implemented method for quantifying an impact of a workplace wellness program, the method comprising:
receiving workplace wellness program data comprising:
cohort health risk data for one or more cohort groups subject to the workplace wellness program, the cohort health risk data for each cohort group comprising:
a first population health risk profile indicative of health risk categorizations for employees in the cohort group at a start of a time span associated with the cohort group; and
a second population health risk profile indicative of health risk categorizations for the employees in the cohort group at an end of the time span associated with the cohort group;
direct cost data indicative of an average direct cost associated with a health risk; and
total cost data indicative of a ratio of total cost avoided to direct cost avoided;
determining a number of employees subject to the workplace wellness program;
normalizing the cohort health risk data for the one or more cohort groups to generate a normalized number of risk avoided per employee for a given duration of time;
determining an average direct cost associated with a health risk based at least in part on the direct cost data;
determining a ratio of total cost avoided to direct cost avoided based at least in part on the total cost data; and
determining a presenteeism value indicative of a total cost avoided over the given duration of time based at least in part on a product of the normalized number of risk avoided per employee for the given duration of time, the number of employees subject to the workplace wellness program, the average direct cost associated with a health risk and the ratio of total cost avoided to direct cost avoided.

11. The method of claim 10, wherein normalizing the cohort health risk data for the one or more cohort groups to generate a normalized number of risk avoided per employee for a given duration of time comprises:
for each of the one or more cohort groups, determining a rate of risk avoidance for the given duration of time based at least in part on shifts in health risks categorizations between the first population health risk profile and the second population health risk profile; and
averaging the rates of risk avoidance for the one or more cohort groups to generate the normalized number of risk avoided per employee for the given duration of time.

12. The method of claim 10, further comprising determining an estimated number of risks avoided based at least in part on a product of the normalized number of risk avoided and the number of employees subject to the workplace wellness program.

13. The method of claim 10, further comprising determining a direct cost avoided based at least in part on a product of the average direct cost associated with a health risk and the estimated number of risks avoided.

14. The method of claim 10, further comprising determining an indirect cost avoided based at least in part on a product of the average direct cost avoided and the ratio of indirect cost to direct cost.

15. The method of claim 10, further comprising generating a modified version of the workplace wellness program based at least in part on the presenteeism value.

16. The method of claim 10, the steps further comprising:
determining whether the presenteeism value satisfies a presenteeism value threshold; and
in response to determining that the presenteeism value does not satisfy the presenteeism value threshold:
generating a modified version of the workplace wellness program; and
providing for display of a workplace wellness program content page comprising information regarding the modified version of the workplace wellness program.

17. A non-transitory computer readable storage medium having program instructions stored thereon that are executable by one or more processors to cause the following steps for quantifying an impact of a workplace wellness program:
receive workplace wellness program data comprising:
cohort health risk data for one or more cohort groups subject to the workplace wellness program, the cohort health risk data for each cohort group comprising:
a first population health risk profile indicative of health risk categorizations for employees in the cohort group at a start of a time span associated with the cohort group; and
a second population health risk profile indicative of health risk categorizations for the employees in the cohort group at an end of the time span associated with the cohort group;
direct cost data indicative of an average direct cost associated with a health risk; and
total cost data indicative of a ratio of total cost avoided to direct cost avoided;
determine a number of employees subject to the workplace wellness program;
normalize the cohort health risk data for the one or more cohort groups to generate a normalized number of risk avoided per employee for a given duration of time;
determine an average direct cost associated with a health risk based at least in part on the direct cost data;
determine a ratio of total cost avoided to direct cost avoided based at least in part on the total cost data; and
determine a presenteeism value indicative of a total cost avoided over the given duration of time based at least in part on a product of the normalized number of risk avoided per employee for the given duration of time, the number of employees subject to the workplace wellness program, the average direct cost associated with a health risk and the ratio of total cost avoided to direct cost avoided.

18. The medium of claim 17, wherein normalizing the cohort health risk data for the one or more cohort groups to generate a normalized number of risk avoided per employee for a given duration of time comprises:
for each of the one or more cohort groups, determining a rate of risk avoidance for the given duration of time based at least in part on shifts in health risks categorizations between the first population health risk profile and the second population health risk profile; and
averaging the rates of risk avoidance for the one or more cohort groups to generate the normalized number of risk avoided per employee for the given duration of time.

19. The medium of claim 17, the steps further comprising determining an estimated number of risks avoided based at least in part on a product of the normalized number of risk avoided and the number of employees subject to the workplace wellness program.

20. The medium of claim 17, the steps further comprising determining a direct cost avoided based at least in part on a product of the average direct cost associated with a health risk and the estimated number of risks avoided.

21. The medium of claim 17, the steps further comprising determining an indirect cost avoided based at least in part on a product of the average direct cost avoided and the ratio of indirect cost to direct cost.

22. The medium of claim 17, the steps further comprising generating a modified version of the workplace wellness program based at least in part on the presenteeism value.

23. The medium of claim 17, the steps further comprising:
determining whether the presenteeism value satisfies a presenteeism value threshold; and
in response to determining that the presenteeism value does not satisfy the presenteeism value threshold:
generating a modified version of the workplace wellness program; and
providing for display of a workplace wellness program content page comprising information regarding the modified version of the workplace wellness program.
